(19) United States
(12) Patent Application Publication
(10) Pub. No.: US 2025/0080014 A1
(43) Pub. Date: Mar. 6, 2025

(54) METHOD FOR RAPID DE-EXCITATION OF A ROTOR OF A SEPARATELY EXCITED SYNCHRONOUS MACHINE OF A MOTOR VEHICLE, SEPARATELY EXCITED SYNCHRONOUS MACHINE FOR A MOTOR VEHICLE AND MOTOR VEHICLE

(71) Applicant: AUDI AG, Ingolstadt (DE)

(72) Inventor: Daniel RUPPERT, Lenting (DE)

(21) Appl. No.: 18/820,020

(22) Filed: Aug. 29, 2024

(30) Foreign Application Priority Data
Aug. 30, 2023 (DE) 102023123314.9

(51) Int. Cl. H02P 3/12; H02K 9/28; H02K 11/00

(52) U.S. Cl. CPC H02P 3/12; H02K 9/28; H02K 11/0094; H02P 2207/05

(57) ABSTRACT

A method for rapid de-excitation of a rotor of a separately excited synchronous machine of a motor vehicle, wherein the motor vehicle or the synchronous machine includes an excitation circuit with at least one transistor that controls a rotor current of the synchronous machine, wherein, in a normal mode of the motor vehicle or of the synchronous machine, the at least one transistor is operated in a switching mode in which the at least one transistor realizes an electronic switch, and wherein, in an emergency mode of the motor vehicle or of the synchronous machine, the at least one transistor is operated in a resistance mode in which the at least one transistor realizes a resistance that at least partially dissipates the rotor current.

### BACKGROUND

### Technical Field

The present disclosure relates to a method for rapid de-excitation of a rotor of a separately excited synchronous machine of a motor vehicle, wherein the motor vehicle or the synchronous machine comprises an excitation circuit with at least one transistor for controlling a rotor current of the synchronous machine. The present disclosure, moreover, relates to a separately excited synchronous machine for a motor vehicle, comprising a rotor, an excitation circuit module which realizes an excitation circuit having at least one transistor for controlling a rotor current of the synchronous machine. In addition, the present disclosure relates to a motor vehicle. cl Description of the Related Art

Separately excited synchronous machines are electrical machines that are used, in particular, as a way of propulsion for motor vehicles designed as electric or hybrid vehicles. In contrast to permanently excited synchronous machines, in which permanent magnets are installed in or on the rotor, the rotor of a separately excited synchronous machine comprises windings consisting of a conductor wire that can be energized with a rotor current. The rotor current, which can also be referred to as excitation current, induces a magnetic field in the rotor, which interacts with a magnetic field present on a stator of the synchronous machine, so that electrical energy is converted into kinetic energy or vice versa. The electrical voltage required for this is provided by a high-voltage battery of the motor vehicle, wherein the corresponding direct current is impressed into the rotor by way of loop rings. Power modules are provided to control the mode of the synchronous machine, in particular an excitation circuit module for the rotor, wherein the power modules comprise semiconductor components such as transistors. Examples of corresponding synchronous machines are known from U.S. 2013/0193903 A1, DE 10 2016 219 770 A1 or DE 10 2021 211 472 A1.

When operating a separately excited synchronous machine, situations are conceivable in which rapid de-excitation of the rotor, which is to say, the fastest possible reduction of the rotor current and therefore the magnetic field of the rotor, is desired or required. An example of such a situation is an accident in which the rotor must be de-energized as quickly as possible, namely, in order to dissipate the energy and switch off the electric drive torque.

### BRIEF SUMMARY

The present disclosure provides an improved concept in connection with rapid de-excitation of a rotor of a separately excited synchronous machine.

According to the disclosure, a method of the aforementioned type in that in a normal mode of the motor vehicle, or of the synchronous machine, the at least one transistor is operated in a switching mode in which it realizes an electronic switch, wherein in an emergency mode of the motor vehicle, or of the synchronous machine, the at least one transistor is operated in a resistance mode, in which it realizes a resistance, wherein, for rapid de-excitation of the rotor, the rotor current is at least partially dissipated by way of the at least one transistor realizing the resistance.

The transistor is a component of the excitation circuit that is used for switching processes in the context of controlling and energizing the rotor during normal mode of the motor vehicle or of the synchronous machine. In the framework of normal mode or respectively of switching mode, by way of a control voltage, which can also be referred to as the gate voltage, the transistor can be brought into two switching states, namely a passing or “on” state and a closed or “off” state. In the passing state, the transistor is low-impedance for the rotor current to be controlled and has a value of approximately 0 ohms. In the closed state, the transistor for the rotor current to be controlled has a high-impedance. Preferably, all circuit states provided for in normal mode can be achieved as regards the at least one transistor by way of the passing and closed states. Normal mode refers, in particular, to situations in which the synchronous machine is used for traction of the motor vehicle or in the context of energy regeneration or respectively recuperation. In general, normal mode refers to accident-free situations of the motor vehicle or respectively of the synchronous machine.

The present disclosure is, in particular, based on the idea of using the transistor in emergency mode for the purpose of de-exciting the rotor as quickly as possible, namely by, in particular, bringing this transistor into an atypical operating range in which it represents a resistance, preferably an ohmic resistance. In this situation, the transistor therefore has a value for the resistance that lies between the value of this transistor realizing the closed switch and the value of this transistor realizing the open switch. In the emergency mode, the rotor or excitation current flows through the transistor forming the resistance, whereby the rotor current is accordingly dissipated. An additional reduction of the rotor current typically takes place by way of other current-carrying components that each realize a resistance, for example by way of the windings of the rotor.

Preferably, the value for the resistance can be controlled, for example by way of the control voltage, so that it can be adjusted according to the situation, in particular to realize the fastest possible de-excitation. In particular, it may be provided that the at least one transistor in the resistance mode is operated in a linear mode in which it realizes a variable resistance. In this way, the transistor can be operated as regards the control or gate voltage in a blocking range realizing the “off” state and a passing range realizing the “on” state. In the blocking range, the control voltage is low, wherein with a collector-emitter or source-drain voltage applied to the transistor, the resulting rotor current, which represents the collector-emitter or source-drain current with respect to the transistor, is approximately 0. In the passing range, the control voltage is sufficiently high so that the rotor current can flow through this transistor. Between the blocking range and the passing range there is a linear range, possibly narrow, in which the resistance decreases in a substantially linear manner with an increase in the control voltage, so that in this range the rotor current increases in a substantially linear manner with an increase in the control voltage. The control voltage can therefore be specifically brought into the linear range in emergency mode. The control voltage can, moreover, be specifically set to a value within the linear range so that the resulting resistance is as advantageous or respectively appropriate as possible for the current situation.

In the method according to the disclosure, it may be provided that, in the emergency mode, the excitation circuit is brought into a switching state such that the rotor current is dissipated in a freewheeling mode in which the at least one transistor realizing the resistance is integrated. In this embodiment, the excitation circuit is switched in such a way that a closed circuit is created in which the rotor current circulates. The or a high-voltage battery of the motor vehicle is not integrated in this circuit, so that the rotor current is only driven by the inductance of the windings of the rotor. Inasmuch as the electric current circulating in this circuit flows through the transistor that realizes the resistance, this current flow is accordingly inhibited or alternatively reduced.

In the emergency mode, the excitation circuit can be alternatingly brought into a plurality of different switching states in which the rotor current is dissipated by way of different transistors, each of which realizes a resistance. In this manner, it can be provided that the excitation circuit comprises a plurality of transistors, wherein some of these transistors also act as switches in emergency mode, so that the remaining transistors, which act as resistances, can be energized with the rotor current. In this manner, it is conceivable that in each of these possible switching states one of the transistors acts as the resistance energized with the rotor current, whereas the switching position of the remaining transistor or transistors causes the transistor realizing the resistance to be energized. This approach is advantageous because operating the transistor as a resistance causes it to heat up, whereas operating the transistors alternatingly as resistances leads to uniform heat reduction by way of various transistors. This simplifies any necessary cooling and extends the service life of these components.

An asymmetrical full-bridge circuit comprising a plurality of transistors is preferably used as the excitation circuit. A bipolar transistor with an insulated gate electrode, which is to say, a so-called IGBT, or a metal-oxide-semiconductor field-effect transistor, which is to say, a so-called MOSFET, is preferably used as the at least one transistor. Various power semiconductor technologies are conceivable, such as silicon IGBTs and/or silicon MOSFETs and/or silicon carbide MOSFETs.

According to a possible specific embodiment, it is provided that the full-bridge circuit comprising two transistors is used as the excitation circuit, wherein in the emergency mode the excitation circuit is alternatingly brought into two different switching states, wherein the rotor current in one of the switching states is dissipated in a high-side freewheeling mode by way of one of the transistors, wherein the rotor current in the other of the switching states is dissipated in a low-side freewheeling mode by way of the other of the transistors.

As regards normal mode, it may be provided that the excitation circuit is brought into a switching state in such a way that the rotor current is built up. This corresponds to starting the synchronous machine or the case in which a drive torque is generated for the motor vehicle by way of the synchronous machine.

In normal mode, the excitation circuit can be brought into a switching state in such a way that electrical energy is recovered from the synchronous machine to a high-voltage battery of the motor vehicle and/or to an intermediate circuit capacitor. This involves converting or recuperating kinetic energy from the motor vehicle or the rotor into electrical energy, which in turn is stored in the high-voltage battery and/or the intermediate circuit capacitor.

It is also conceivable that in normal mode the excitation circuit is brought into a switching state in such a way that the rotor current is dissipated, in particular in a freewheeling mode. This case more or less represents a planned de-excitation of the rotor, which is slower than the rapid de-excitation described above.

According to the disclosure, the task is further solved in a separately excited synchronous machine of the aforementioned type in that it comprises a control device which is set up to apply a control voltage to a control terminal of the at least one transistor, in particular a gate terminal, in such a way that, in a normal mode of the synchronous machine, the at least one transistor can be operated in a switching mode in which it realizes an electronic switch, and that, in an emergency mode of the synchronous machine, the at least one transistor can be operated in a resistance mode in which it realizes a resistance, wherein for rapid de-excitation of the rotor, the rotor current can be at least partially dissipated by way of the at least one transistor realizing the resistance. The synchronous machine according to the disclosure can be multiphase, in particular three-phase. All the advantages, features, and aspects elucidated in connection with the method according to the disclosure are equally transferable to the separately excited synchronous machine according to the disclosure and vice versa.

In the separately excited synchronous machine according to the disclosure, it may be provided that the high-voltage battery is electrically connected to the rotor via the excitation circuit module. Additionally or alternatively, it is conceivable that the high-voltage battery is electrically connected to a stator of the synchronous machine via a main converter module realizing a main converter. The excitation circuit module can have a performance class of 15 kW. The main converter module can be realized as a B6 bridge circuit. The excitation circuit module and/or the main converter module may be referred to as a power module. The respective module can have a circuit board with semiconductor components connected to it, in particular soldered on. The rotor or respectively excitation current can be supplied to the rotor via an electrical sliding contact.

According to the disclosure, it may be provided that the excitation circuit module and/or the or a main converter module is/are coupled to at least one intermediate circuit capacitor. The intermediate circuit capacitor, which can also be referred to as intermediate circuit capacitance, is a capacitor arranged in an intermediate circuit of the power electronic system. The intermediate circuit capacitor can be used to temporarily store electrical energy, particularly in the context of fast, transient processes. The excitation circuit module and the main converter module are therefore preferably physically connected to the at least one intermediate circuit capacitor and are fed by it. The at least one intermediate circuit capacitor is in turn connected to the high-voltage battery.

It is particularly advantageous that the synchronous machine according to the disclosure comprises at least one cooling module which is thermally coupled to the excitation circuit module, so that, in the emergency mode, the at least one transistor, by way of which the rotor current is dissipated, can be cooled via the at least one cooling module. As already mentioned above, the dissipation of electrical energy by way of the transistor leads to generation of heat. The cooling module can be configured as a heat sink, in particular a cooling plate, upon which the excitation circuit module and possibly the main converter module are arranged. The cooling effect realized by way of the cooling module can be brought about by air cooling. For example, the cooling module may comprise corresponding cooling ribs or fins via which heat can be transferred from the cooling module to the ambient air. Additionally or alternatively, this cooling effect can be brought about by a cooling liquid, in particular a circulating cooling liquid, wherein the cooling module can have cooling channels through which the cooling liquid flows. In this way, the cooling module can be incorporated or integrated into a cooling circuit, in particular of the motor vehicle. The cooling liquid, which is in particular water or a water-glycol mixture, can circulate in the cooling circuit. A cooling element such as a heat exchanger can be integrated into the cooling circuit. A refrigerating machine can be realized by way of the cooling circuit.

In addition, the task of the present disclosure is solved by a motor vehicle which, according to the disclosure, comprises a separately excited synchronous machine as described above and a high-voltage battery for supplying power to the separately excited synchronous machine. All the advantages, features and aspects elucidated in connection with the method according to the disclosure and the separately excited synchronous machine according to the disclosure are equally transferable to the motor vehicle according to the disclosure and vice versa. The motor vehicle according to the disclosure can also be referred to as an electric or hybrid vehicle.

### BRIEF DESCRIPTION OF THE SEVERAL VIEWS OF THE DRAWINGS

Further advantages and details of the present disclosure are shown in the following embodiments and in the figures.

FIG. 1 is a schematic view of a motor vehicle as per the disclosure according to an embodiment example, comprising a separately excited synchronous machine as per the disclosure according to an embodiment example, wherein a method as per the disclosure according to an embodiment example is executed in the motor vehicle,

FIG. 2 is a circuit diagram of a power electronic system of the motor vehicle of FIG. 1,

FIG. 3 is a coordinate system with a characteristic curve of a transistor of the power electronic system of FIG. 2, and

FIGS. 4-7 are circuit diagrams of an excitation circuit of the power electronic system in FIG. 2 in different switching states.

### DETAILED DESCRIPTION

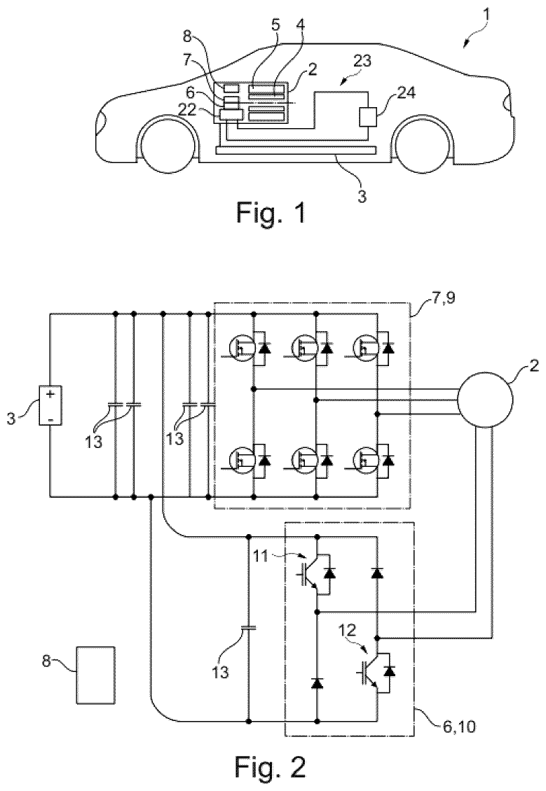

FIG. 1 shows a motor vehicle 1 as per the disclosure according to an embodiment example, comprising a separately excited synchronous machine 2 as per the disclosure according to an embodiment example. In the following, a method as per the disclosure according to an embodiment example is elucidated with reference to the motor vehicle 1 as well as the synchronous machine 2.

The motor vehicle 1 comprises a high-voltage battery 3, which is provided for supplying power to the synchronous machine 2 and which can also be referred to as a high-voltage energy storage device. The synchronous machine 2 is an electric machine with a rotor 4 and a stator 5 intended for traction of the motor vehicle. The synchronous machine 2, moreover, comprises an excitation circuit module 6 and a main converter module 7, which are provided for controlling and energizing the windings of the rotor 4 and the stator 5. A control device 8 of the synchronous machine 2 is provided to control these power modules. Although the modules 6, 7 and the control device 8 are components of the synchronous machine 2 in the embodiment example shown, which is to say, the synchronous machine 2 together with these components represents a structural unit, they can also be provided distributed over the motor vehicle 1.

With reference to FIG. 2, details of the modules 6, 7 are elucidated below, wherein this figure shows a circuit diagram of a power electronics system of the motor vehicle 1 comprising the high-voltage battery 3 and the modules 6, 7. Modules 6, 7 each comprise a printed circuit board or respectively a circuit board on which electronic components are soldered. The main converter module 7 realizes a main converter 9 and connects the stator 5 to the high-voltage battery 3. The main converter 9 is a B6 bridge circuit so that the synchronous machine 2 is accordingly three-phase.

The excitation circuit module 6 realizes an excitation circuit 10 for controlling the rotor or respectively excitation current of the synchronous machine 2. This means that the rotor 4 is connected to the high-voltage battery 3 via the excitation circuit module 6 or respectively the excitation circuit 10. The excitation circuit 10 comprises two transistors 11, 12 and realizes an asymmetrical full bridge circuit. By way of example, the transistors 11, 12 are bipolar transistors with insulated gate electrodes, which is to say, IGBTs for short, but can also be metal-oxide-semiconductor field-effect transistors, which is to say, MOSFETs for short. The control device 8 is provided to control the transistors 11, 12, which control device generates the corresponding control or respectively gate voltages. The control device 8 is only indicated schematically in FIG. 2, wherein the lines between the control device 8 and the modules 6, 7 are not shown for the sake of clarity.

A plurality of intermediate circuit capacitors 13 are integrated into the power result system. In a concrete manner, both the excitation circuit 10 and the main converter 9 are coupled with intermediate circuit capacitor(s) 13.

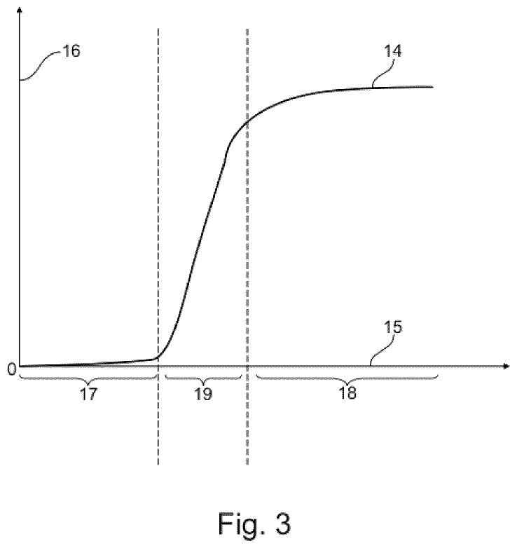

For a better understanding of the method according to the disclosure, reference is now made to FIG. 3, which shows a characteristic curve 14 of each of the two transistors 11, 12. Thus, the x-axis 15 relates to the value of the control voltage which can be generated by way of the control device 8 and which is applied to the gate of the respective transistor 11, 12. The y-axis 16 relates to the value of the resulting electrical current through the respective transistor 11, 12, which is to say, the collector-emitter or alternatively source-drain current at a collector-emitter or source-drain voltage applied to the respective transistor 11, 12.

It can be seen that the transistors 11, 12 each have different operating ranges with different characteristics relating to the characteristic curve 14. In this way, the transistors 11, 12 can be operated in a blocking range 17 realizing an “off” state and in a passing range 18 realizing an on-state. As regards the ranges 17, 18, the transistor 11, 12 realizes a switch for the collector-emitter or source-drain current, which can be switched “on” and “off” or alternatively opened and closed by way of the corresponding control voltage. Inasmuch as the control voltage is low and the transistor 11, 12 is consequently operated in the blocking range 17, the resulting rotor current is approximately 0. In this case, there is a high-impedance resistance with respect to the rotor current and therefore an open switch, which is realized by way of the respective transistor 11, 12. If the values for the control voltage are sufficiently high, the transistor is operated in the passing range 18 in which the rotor current can flow through the respective transistor 11, 12. In this case, there is a low-impedance resistance as regards the rotor current, which is likewise realized by the respective transistor 11, 12. Between the ranges 17, 18 there is a narrow, linear range 19 in which the resistance realized by way of the respective transistor 11, 12 decreases in a substantially linear manner with an increase in the control voltage, so that in the linear range 19 the rotor current increases in a substantially linear manner with an increase in the control voltage.

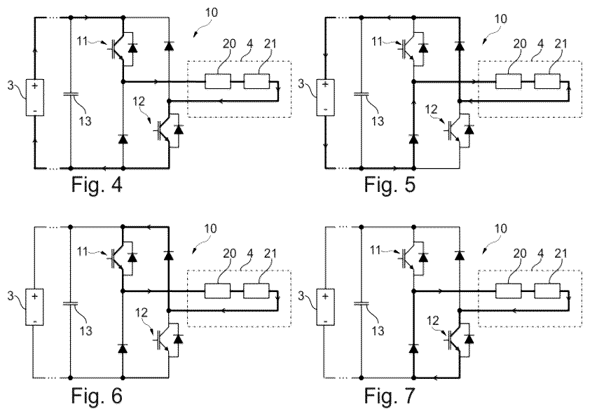

Reference is made below to FIG. 4 through FIG. 7, which respectively show the excitation circuit 10 in different switching states. In this way, the motor vehicle 1 or alternatively the synchronous machine 2 can be operated in a normal mode and in an emergency mode. All switching states shown in FIG. 4 through FIG. 7 can be present in the framework of normal mode, wherein the switching states shown in FIG. 6 and FIG. 7 can also be provided in the framework of emergency mode. In the framework of emergency mode, the rotor 4 is rapidly de-excited, for example, due to an accident. An ohmic resistance 20 as well as an inductance 21 realized by the windings of the rotor 4 are additionally shown in FIG. 4 through FIG. 7. The current flows are illustrated in these figures by bold lines and corresponding arrowheads.

FIG. 4 shows a switching state of the excitation circuit 10 in normal mode, in which the rotor current is built up. In this state, a control voltage generated by the control device 8 is applied to the gate of both transistors 11, 12 in such a way that both transistors 11, 12 are in the passing range 18. The transistors 11, 12 therefore each realize a closed switch. In this state, an excitation field is built up or maintained in the rotor 4 or respectively a drive torque is generated for the motor vehicle 1.

FIG. 5 shows a switching state of the excitation circuit 10 during normal mode, in which current is fed back into the high-voltage battery 3 or respectively the intermediate circuit capacitor 13. In this state, a control voltage generated by the control device 8 is applied to the gate of both transistors 11, 12 in such a way that both transistors 11, 12 are in the blocking range 17. The transistors 11, 12 therefore respectively realize an open switch. In this state, a deceleration torque is specifically generated for the motor vehicle 1, which is correspondingly in a recuperation mode.

FIG. 6 shows a switching state of the excitation circuit 10, which will be elucidated here below with reference to normal mode. In this state, control voltages generated by the control device 8 are applied to the gates of the transistors 11, 12 in such a way that the transistor 11 is in the passing range 18 and the transistor 12 is in the blocking range 17. In this switching state, the rotor current driven by the inductances 21 circulates through the windings of the rotor 4 and through the transistor 11 as part of a high-side freewheeling mode.

FIG. 7 shows a switching state of the excitation circuit 10, which will also be elucidated here below with reference to normal mode. In this state, control voltages generated by the control device 8 are applied to the gates of the transistors 11, 12 in such a way that the transistor 11 is in the blocking range 17 and the transistor 12 is in the passing range 18. In this switching state, the rotor current driven by the inductances 21 circulates through the windings of the rotor 4 and through the transistor 12 as part of a low-side freewheeling mode.

In the switching states shown in FIG. 6 and FIG. 7, the windings of the rotor 4 are decoupled from the high-voltage battery 3 and from the intermediate circuit capacitor 13, so that the rotor current is dissipated due to the resistance 20. Expressed in another way, the electrical energy stored in the rotor current is converted into thermal energy. A de-excitation of the rotor 4 occurs. This does, however, require a period of time that is too long for certain situations, such as an accident situation. Against this background, the present disclosure proposes a concept for rapid de-excitation of rotor 4 as quickly as possible. This so-called emergency mode is realized in the framework of the switching states shown in FIG. 6 and FIG. 7, which will be elucidated below.

With reference to FIG. 6, the control voltage applied to the transistor 11 is generated in such a way that it is no longer in the passing range 18, but rather, instead, in the linear range 19. Accordingly, this transistor 11, through which the rotor current flows, no longer merely realizes a closed switch, but rather, instead, an ohmic resistance. The dissipation of the electrical energy is therefore not carried out exclusively by way of the resistance 20, but rather also by way of the transistor 11, which also realizes a resistance. In comparison to normal mode, the rotor 4 is therefore the de-excitation correspondingly occurs faster. The control voltage can be set, for example using the characteristic curve 14, in such a way that the resistance realized by way of the transistor 11 assumes a situation-specific ideal value.

Similarly, in the framework of the switching state shown in FIG. 7, the control voltage applied to the transistor 12 is generated in such a way that it is also in the linear range 19. In this case, even in the state shown in FIG. 7, therefore, not only the resistance 20 but rather also the transistor 12, which also realizes a resistance, is used to de-excite the rotor 4. Here, too, the realized resistance can be set in a situation-specific manner.

An optional aspect relating to the emergency mode is elucidated below. For example, the excitation circuit 10 is alternatingly switched from the switching state shown in FIG. 6 to the switching state shown in FIG. 7, this by way of a corresponding cyclical change in the control voltage generated by the control device 8. In these different switching states, the rotor current is alternatingly dissipated by the transistors 11, 12. Any heating of the resistances resulting from the dissipation of the corresponding electrical energy is therefore divided between the two transistors 11, 12 and is therefore reduced for the individual transistors 11, 12.

To dissipate heat from the transistors 11, 12, with particular renewed reference to FIG. 1, a cooling module 22 is provided which is thermally coupled to the excitation circuit module 6. The one cooling module 22, which forms a cooling plate, is integrated into a cooling circuit 23 of the motor vehicle 1, wherein a cooling liquid such as water circulates in the cooling circuit 23, which has a heat exchanger 24. The cooling module has cooling channels through which the coolant flows. The cooling module 22 moreover comprises cooling ribs or fins so that the heat is emitted into the ambient air.

German patent application no. 102023123314.9, filed Aug. 30, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for rapid de-excitation of a rotor of a separately excited synchronous machine of a motor vehicle, wherein the motor vehicle or the synchronous machine includes an excitation circuit with at least one transistor that controls a rotor current of the synchronous machine, the method comprising:
in a normal mode of the motor vehicle or of the synchronous machine, operating the at least one transistor in a switching mode in which the at least one transistor realizes an electronic switch; and
in an emergency mode of the motor vehicle or of the synchronous machine, operating the at least one transistor in a resistance mode in which the at least one transistor realizes a resistance that at least partially dissipates the rotor current.

2. The method according to claim 1, wherein the operating the at least one transistor in the resistance mode includes operating the at least one transistor in a linear mode in which the at least one transistor realizes a variable resistance.

3. The method according to claim 1, wherein, in the emergency mode, the excitation circuit is brought into a switching state in which the rotor current is dissipated in a freewheeling mode in which the at least one transistor realizing the resistance is integrated.

4. The method according to claim 1, wherein, in the emergency mode, the excitation circuit is alternatingly brought into a plurality of different switching states in which the rotor current is dissipated by way of different transistors, and
wherein each of the different transistors realizes a resistance.

5. The method according to claim 1, wherein the excitation circuit includes an asymmetrical full-bridge circuit having a plurality of transistors and/or the at least one transistor includes a bipolar transistor with an insulated gate electrode or a metal-oxide semiconductor field-effect transistor.

6. The method according to claim 1, wherein the excitation circuit includes a full-bridge circuit with two transistors, and
wherein the method further comprises:
in the emergency mode, alternatingly bringing the excitation circuit into two different switching states,
wherein the rotor current in a first one of the two different switching states is dissipated in a high-side freewheeling mode by way of a first one of the two transistors, and
wherein the rotor current in a second one of the two different switching states is dissipated in a low-side freewheeling mode by way of a second one of the two transistors.

7. The method according to claim 1, further comprising:
in normal mode, bringing the excitation circuit into a switching state in which the rotor current is built up, or in which electrical energy is recovered from the synchronous machine to a battery of the motor vehicle and/or to an intermediate circuit capacitor, or in which the rotor current is dissipated in a freewheeling mode.

8. A separately excited synchronous machine for a motor vehicle, the separately excited synchronous machine comprising:
a rotor;
an excitation circuit module that realizes an excitation circuit having at least one transistor that, in operation, controls a rotor current of the synchronous machine; and
a control device that, in operation, applies a control voltage to a control terminal of the at least one transistor such that:
in a normal mode of the synchronous machine, the at least one transistor is operated in a switching mode in which the at least one transistor realizes an electronic switch, and
in an emergency mode of the synchronous machine, the at least one transistor is operated in a resistance mode in which the at least one transistor realizes a resistance that at least partially dissipates the rotor current.

9. The separately excited synchronous machine according to claim 8, further comprising:
a battery that is electrically connected to the rotor via the excitation circuit module and/or to a stator of the synchronous machine via a main converter module that realizes a main converter.

10. The separately excited synchronous machine according to claim 9,
wherein the excitation circuit module and/or the main converter module is/are coupled to at least one intermediate circuit capacitor.

11. The separately excited synchronous machine according to claim 8, further comprising:
at least one cooling module that is integrated into a cooling circuit and is thermally coupled to the excitation circuit module, and
wherein, in the emergency mode, the at least one transistor, by way of which the rotor current is dissipated is cooled via the at least one cooling module.

12. A motor vehicle, comprising:
the separately excited synchronous machine according to claim 8; and
a battery that, in operation, supplies power to the separately excited synchronous machine.
